(19) United States
(12) Patent Application Publication
(10) Pub. No.: US 2007/0184711 A1
(43) Pub. Date: Aug. 9, 2007

(54) ELECTRICAL MODULE

(75) Inventors: Guy C. Thrap, Del Mar, CA (US); Ray Soliz, Escondido, CA (US); Jeffrey D. Johnstone, San Diego, CA (US); Steven J. Stanley, San Diego, CA (US)

Correspondence Address: HENSLEY KIM & EDGINGTON, LLC, 1660 LINCOLN STREET, SUITE 3050, DENVER, CO, 80264-3103, US

(73) Assignee: MAXWELL TECHNOLOGIES, INC., San Diego, CA (US)

(21) Appl. No.: 11/611,770

(22) Filed: Dec. 15, 2006

Related U.S. Application Data
(60) Provisional application No. 60/751,389, filed on Dec. 15, 2005.

(51) Int. Cl. F24H 7/00; H01R 3/00

(52) U.S. Cl. 439/500; 126/400

(57) ABSTRACT

It is desirable to be able to securely connect individual electrical components within an electrical module. An electrical module is provided in which a plurality of energy storage components are connected together using a clamp instead of wiring or bus bar connections. In one configuration, for example, a first energy storage component comprising a first terminal and second terminal is connected to a second energy storage component comprising a third terminal and a fourth terminal. The first terminal of the first energy storage component is electrically connected to a third terminal of the second energy storage component using a clamp comprising a recess. The recess of the clamp receives at least a portion of the first terminal of the first energy storage component and at least a portion of the third terminal of the second energy storage component. The clamp electrically connects the first terminal of the first energy storage component and the third terminal of the second energy storage component and secures the first energy storage component and the second energy storage component in a generally in-line configuration.

### CROSS-REFERENCE TO RELATED APPLICATIONS

This application claims the benefit of U.S. provisional application No. 60/751,389 entitled “Electrical module clamp” and filed by Guy C. Thrap and Ray Soliz on Dec. 15, 2005, which is hereby incorporated by reference as though fully set forth herein.

### INTRODUCTION

a. Field of the Invention

The instant invention relates to an electrical module. In particular, the instant invention relates to an electrical module comprising a plurality of energy storage devices.

b. Introduction

Electrical modules can include energy storage components electrically connected between a pair of module terminals. The energy storage components are often physically and/or electrically connected to other energy storage components and/or a substrate, such as a PC board within the electrical module. Electrical connections between the energy storage components of the electrical module generally include electrical conductors such as wires or bus bars. The energy storage components may be connected in various configurations, such as in series, in parallel, or a combination of series and parallel. Energy storage components may also be connected to a substrate (e.g., a PC board) either individually or collectively within the electrical module.

An energy storage component may comprise a device such as a battery or a capacitor. Batteries, for example, may comprise primary or secondary battery cells. Capacitors, for example, may comprise electrolytic capacitors, tantalum capacitors, ceramic capacitors, double layer capacitors (also referred to as super capacitors or ultracapacitors), or any other type of capacitor cell.

While a particular battery or capacitor energy storage component may be limited in voltage, current, and/or energy storage capacity capabilities, multiple battery and/or capacitor energy storage components may be combined together to provide higher voltage, current, and/or energy storage capacity capabilities. To obtain a higher voltage module from lower voltage components, for example, multiple components may be connected in series between two or more terminals of a module and, in some cases, provided in a container or housing.

The electrical connections used to connect the individual energy storage components to each other and/or to the terminals of the electrical module provide additional resistance for the electrical module, take up volume of the module that could otherwise be used for energy storage capacity or to reduce the overall size of the electrical module, and provide additional locations where damage to the connections can impact the performance of the module. In addition, some electrical modules include individual electrical components that are welded to bus bars or wires to connect the electrical components within the module. Welding, however, can generate heat that may damage the electrical components of the module.

### BRIEF SUMMARY OF THE INVENTION

It is desirable to be able to securely connect individual electrical components within an electrical module. An electrical module is provided in which a plurality of energy storage components are connected together using a clamp instead of wiring or bus bar connections.

In one configuration, for example, a first energy storage component comprising a first terminal and second terminal is connected to a second energy storage component comprising a third terminal and a fourth terminal. The first terminal of the first energy storage component is electrically connected to a third terminal of the second energy storage component using a clamp comprising a recess. The recess of the clamp receives at least a portion of the first terminal of the first energy storage component and at least a portion of the third terminal of the second energy storage component. The clamp electrically connects the first terminal of the first energy storage component and the third terminal of the second energy storage component and secures the first energy storage component and the second energy storage component in a generally in-line configuration.

In another configuration an electrical module is provided in which a first energy storage component comprises a first terminal and second terminal and is connected to a second energy storage component comprising a third terminal and a fourth terminal. A means for clamping at least a portion of the first terminal of the first energy storage component and at least a portion of the third terminal of the second energy storage component is provided that electrically connects the first terminal of the first energy storage component to the third terminal of the second energy storage component, wherein the first energy storage component and the second energy storage component are arranged in a generally in-line configuration

A method for assembling an electrical module is also provided in which the method comprises providing a first energy storage component, a second energy storage component, and a clamp. The clamp is used to secure the first energy storage component to the second energy storage component in a generally in-line configuration by electrically connecting a first terminal of the first energy storage component to a second terminal of the second energy storage component.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a perspective view of a first example of an electrical module comprising a plurality of individual energy storage components secured to a base member.

FIG. 2 depicts a top view of the electrical module of FIG. 1.

FIG. 3 depicts a side view of the electrical module of FIGS. 1 and 2.

FIG. 4 depicts a perspective view of a first example of a clamp that may be used to secure an energy storage component within an electrical module.

FIG. 5 depicts a front view of the clamp of FIG. 4 in a separated configuration.

FIG. 6 depicts a side view of the clamp in the separated configuration depicted in FIG. 5.

FIG. 7 depicts a perspective view of a second example of an electrical module.

FIG. 8 depicts a perspective view of the electrical module of FIG. 7 without a housing of the electrical module in place.

FIG. 9 depicts a perspective view of the electrical module of FIGS. 7 and 8 with two electrical components of the electrical module removed to illustrate a pair of clamps of the electrical module.

FIG. 10 depicts a top view of the electrical module as shown in FIG. 8.

FIG. 11 depicts a side view of the electrical module as shown in FIGS. 8 and 9.

FIG. 12 depicts a front view of the electrical module of FIGS. 7-11.

FIG. 13 depicts a front view of a second example of a clamp that may be used to secure an energy storage component within an electrical module.

FIG. 14 depicts a side view of the clamp of FIG. 13.

FIGS. 15 and 16 depict perspective views of the clamp of FIGS. 13 and 14.

FIG. 17 depicts a third example clamp that may be used to secure an energy storage component within an electrical module.

FIGS. 18 and 19 depict a third example of an electrical module showing fourth and fifth examples of clamps that may be used to secure an energy storage component within the electrical module.

FIG. 20 depicts a cross-sectional view of a portion of the fifth example of a clamp shown in FIGS. 18 and 19.

FIG. 21 depicts a perspective view of fourth example of an electrical module showing a sixth example of a clamp that may be used to secure an energy storage component within the electrical module.

### DETAILED DESCRIPTION OF THE INVENTION

An electrical module is provided that comprises a plurality of energy storage components that are connected in a generally in-line configuration through the use of a clamp. The clamped connection of the individual energy storage components can reduce the equivalent series resistance (ESR) of the module by eliminating the use of at least some internal wiring or bus-bar connections and providing a direct electrical connection or at least a very short conductance path between at least some of the terminals of the energy storage components. The electrical module may include one or more rows of energy storage components connected in a generally in-line configuration and allows for series and/or parallel connection of the energy storage components within the electrical module. The use of the clamps also provides for simplified assembly and disassembly for repair over welded, soldered, or other connections.

The clamps may also serve as heat sinks conducting thermal energy away from the energy storage devices to prevent damage or a loss in performance caused by heat build-up within the electrical module. The clamps may also be relatively heat insensitive compared to soldered or other connections, which could melt at temperatures generated within an electrical module, especially where double layer capacitors are used to generate higher current levels. In addition, the use of the clamps may be relatively tolerance insensitive and be able to connect different types of energy storage components together or energy storage components having varying tolerances.

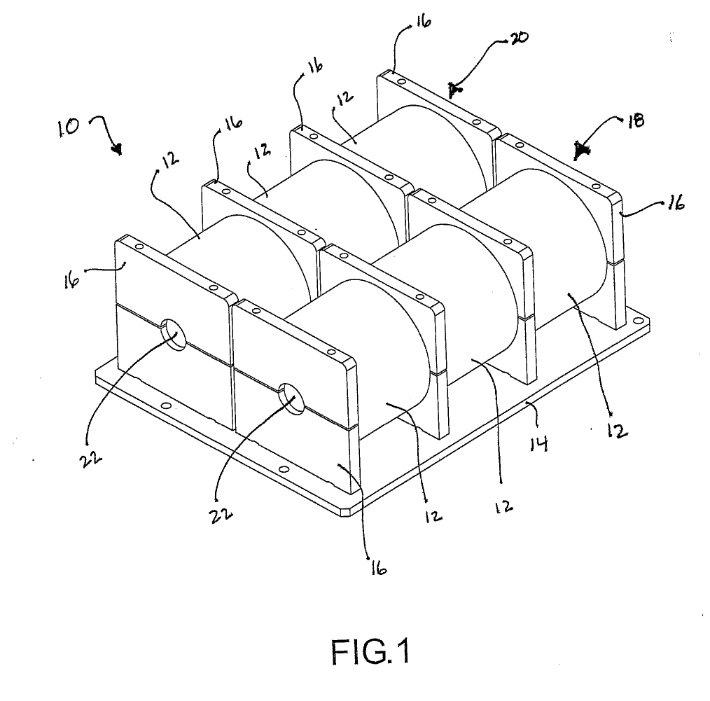

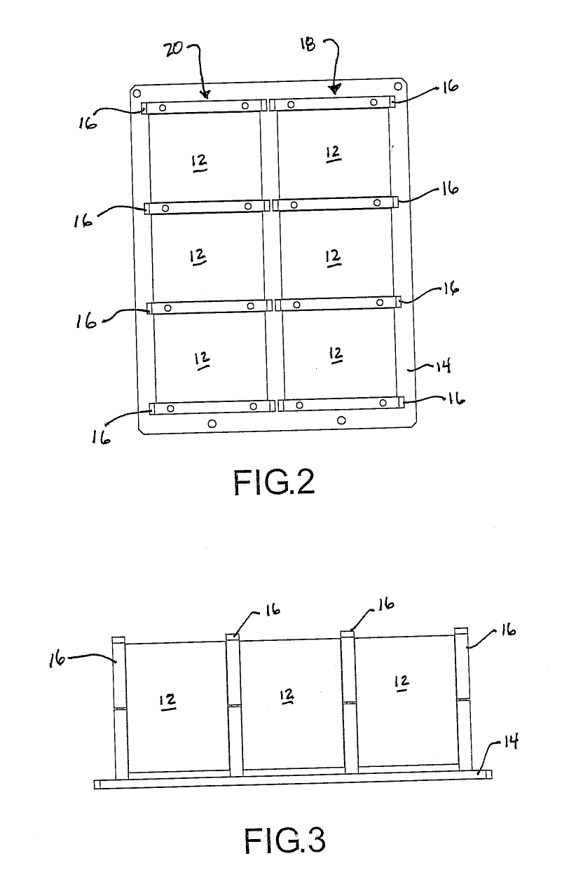

FIG. 1 depicts a perspective view of a first example of an electrical module 10 comprising a plurality of individual energy storage components 12 secured to a base member 14 by a plurality of clamps 16. FIG. 2 depicts top view of the module 10, and FIG. 3 depicts a side view of the module 10. The individual electrical components 12 may comprise any number of energy storage components. The energy storage components may include a single type of energy storage component or various different energy storage components (e.g., different types of batteries, different types of capacitors, and/or a combination of batteries and capacitors). In one particular example, the individual energy storage components 12 comprise double layer capacitors. The base member 14 may comprise any suitable substrate for supporting the electrical components, such as a PC board.

The energy storage components 12 are shown arranged in two rows 18 and 20. The rows 18 and 20 in the example shown in FIG. 1 each include three serially connected energy storage components 12 secured to the base member 14 and each other via the clamps 16. The energy storage components 12 of each row are connected axially and in-line in a series configuration. The axial terminals 22 of the individual energy storage components 12 are maintained in an electrical connection with a terminal 22 of an adjacent electrical component via the clamps 16. The electrical connection may comprise a direct contact between the ends of the terminals 22 of adjacent energy storage components 12 and/or may include a conductive path through the clamps 16 that secure each of the adjacent terminals 22. Even if the terminals 22 of the adjacent energy storage components 12 do not make a solid electrical connection directly with each other, the clamp provides a very short electrical conductive path between the closely spaced terminals 22. This provides a very low equivalent series resistance (ESR) connection between the terminals of the energy storage components 12, without introducing higher resistance or stray current paths commonly present in connectors, such as a bus bar or wire lead connection typically used to electrically connect terminals of energy storage components within a module. The direct connection also allows the electrical components to be closely spaced and can reduce the overall form factor of the module 10.

Where the clamps 16 are thermally conductive, the clamps 16 further perform as a heat sink transferring thermal energy away from the energy storage components 12. Depending on the application, the clamps 16 may provide an adequate heat sink on their own or may be connected to another thermally conductive component to further transfer the thermal energy away from the energy storage components 12. In a double layer capacitor application involving high current flows (e.g., approaching 5000 A over a few milliseconds), the clamps 16 may be thermally connected to a thermally conductive housing (e.g., an aluminum housing) via a thermally conductive, yet non-electrically conductive interface material. In one example, such a thermally conductive and non-electrically conductive thermal interface material may comprise a fiberglass reinforced thermal pad having a thickness of between about 1 mm and 2 mm, although other materials or dimensions are possible. In another example, a convection and/or forced system may also be used to dissipate thermal energy from a heat sink component (e.g., the clamps 16).

In this example, the clamps 16 further secure the energy storage components 12 physically and/or electrically to the base member 14. Although the terminals of the energy storage components are shown in an axial in-line configuration, other configurations (e.g., offset terminals and/or terminals extending from the same side of the electrical component) are also possible.

The rows 18 and 20 of the module 10 may be electrically independent of each other (e.g., as individual sub-modules) or may be interconnected as part of a single electrical module. Where the rows 18 and 20 are electrically independent of each other and comprise individual sub-modules, module terminals may be electrically connected to the terminals 22 of the energy storage components 12 located on the ends of each row. In one configuration, for example, the module terminals are secured in an electrical connection with the terminals 22 of the energy storage components 12 by the clamps 16 located at the end of each row (e.g., the module terminals may be secured in an electrical connection within an opening 24 of the clamp located on the end of a row). Other configurations for making electrical connections to the energy storage components are also possible, however.

In another configuration, the rows 18 and 20 of energy storage components 12 may be electrically connected to each other within the module 10. The rows 18 and 20, for example, may be serially connected to each other or may be connected in parallel with each other. In this manner, the module 10 may comprise a single pair of terminals for the energy storage components 12.

The clamps 16 may also be at least partially electrically conductive (e.g., comprise aluminum or another conductive material) and electrically connect the terminals 22 of the energy storage components 12 to the base member 14 or to another electrical component disposed within the module 10 (e.g., on the base member 14). The base member 14, for example, may comprise an electrical pad or other conductive element at the base of one or more of the clamps 16 that provides an electrical connection to the terminals 22 of the energy storage components 12. In another configuration, the base member 14 may comprise an electrical pad or other conductive element opposite the base of one or more clamps 16. In this manner a connector (e.g., a bolt and/or nut) extending through the clamp 16 and the base member to secure the clamp 16 to the electrical component 16 and the base member 14 may make an electrical connection to the pad on the opposite side of the base member 14. Such electrical connections may be used to monitor and/or compensate for conditions of the energy storage components 12. In one example, voltage monitoring circuits and/or charge balancing circuits may be electrically connected to the clamps 16 and the terminals 22 of the energy storage components 12.

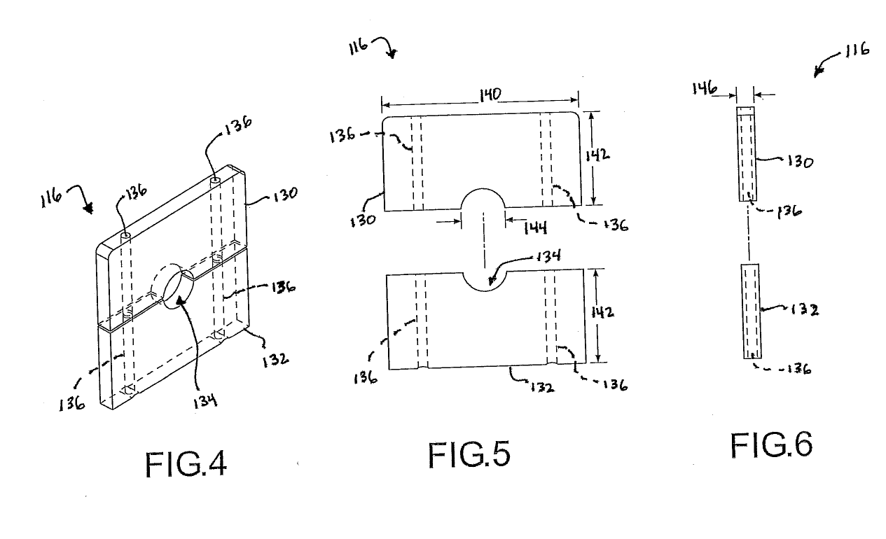

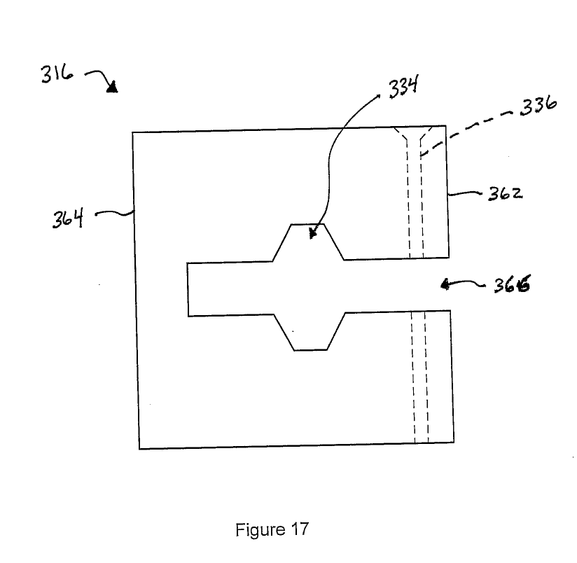

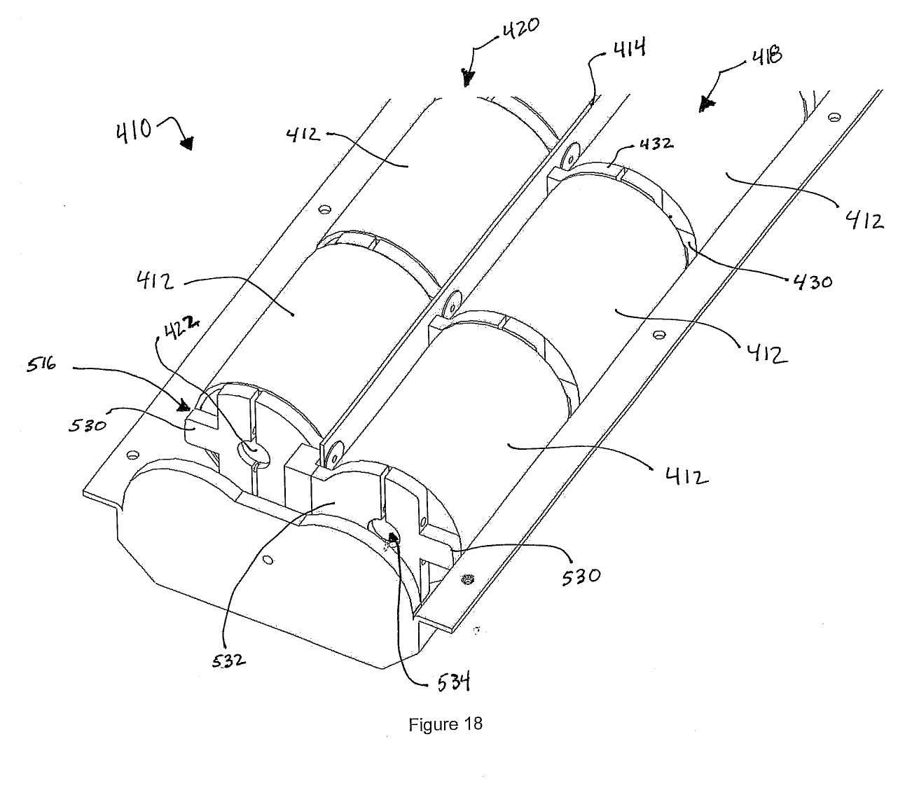

FIG. 4 depicts a perspective view of a first example of a clamp 116 that may be used to secure an energy storage component within an electrical module. The clamp 116 comprises a top portion 130 and a bottom portion 132. At least one of the portions 130 and 132 comprises a recess 134. The recess 134 may comprise a generally semicircular recess as shown in FIG. 4 or may be otherwise shaped to match or engage a terminal of an energy storage component. The recesses 134, for example, may comprise angled walls to ensure a good connection between the clamp 116 and the terminals of the electrical components, especially where significant tolerance variations in the terminals may exist (see, e.g., FIG. 17).

The clamp 116 may be configured to secure an end or a terminal of one or more energy storage components to a substrate and/or to each other. The clamp 116, for example, may be configured to securely hold terminals of two double layer capacitors in a direct electrical connection and/or securely affix the double layer capacitors to a substrate, such as a PC board. Thus, current may flow directly from a terminal of a first one of the energy storage components to a terminal of a second one of the energy storage components. In addition, as described above, where the clamp itself (or a portion of the clamp itself) is conductive, current may flow from one energy storage component to the other energy storage component through the conductive (or conductive portion of) the clamp 116. In addition, where the portions of the energy storage components (e.g., the terminals) are formed of a particular conductive material, such as aluminum, the clamp itself (or the conductive portion thereof) may also be formed of the same conductive material (e.g., aluminum) to prevent galvanic corrosion due to dissimilar metals.

In the example shown in FIG. 4, the top portion 130 and the bottom portion 132 of the clamp 116 further comprise at least one hole 136 (two are shown in the example of FIG. 4) by which the top portion 130 and the bottom portion 132 can be secured together. In one implementation, for example, a connector, such as a bolt, a screw, a rivet, or other connector may be extended through the hole 136. A bolt, for example, may be extended through the hole 136 and engage a connector (e.g., a nut, such as a pem nut pressed into a base member or a T-nut soldered onto the base member) and be used to secure the clamp to the base member. The bolt, for example, may be extended from a top end of the clamp 116 through the hole 136 of the clamp 116 such that its threaded end extends through the base member and a connector such as a pem nut or T-nut is used to secure the bolt on the opposite side of the base member (although the bolt may also be extended in the opposite direction as well). The bolt and the connector can be tightened with respect to each other to secure the clamp 116, the at least one electrical component, and the base member. The hole 136 can also be counter-sunk on the top end to allow the bolt or other connector to sit flush or just below a top surface of the clamp 116. This allows the clamp 116 to provide a better thermal conduction path to another thermal conductor, such as the thermal interface layer described above.

Where an electrical connection from the clamp 116 and/or an energy storage component to the base member is desired, the head of the bolt or the connector (e.g., a pem nut or a T-nut) may be electrically connected (e.g., soldered) to a pad on the opposite side of the base member. Alternatively or additionally, at least one of the bottom edges of an at least partially conductive clamp 116 may be disposed adjacent to a pad disposed on the same side of the base member as the clamp 116.

Although the holes 136 are shown extending entirely through the clamp 116 in the example shown in FIG. 4, the holes 136 may be threaded (e.g., drilled and tapped) and only extend a portion of the way through the clamp 116 to receive a threaded member (e.g., a bolt or screw) extending from the opposite side of the base member to secure the clamp to the base member. Again, the clamp may be electrically connected to the base member on the side of the base member adjacent to the clamp and/or on the opposite side of the base member. The holes 136 may also be counter-sunk at one or both ends so that the head of a male connector (e.g. a bolt) and/or a female connector (e.g., a nut) may be disposed within the counter-sunk hole 136 of the clamp 116.

The module 10 depicted in FIGS. 1-3 may be assembled by providing the base member 14, such as a PC board, and assembling any electrical components or connections on a first side of the base member 14. The base member 14 is then turned over, and the bottom portions 132 of the clamps 116 are placed on and/or connected to the base member 14. In one configuration, for example, pem nuts may be extended into the bottom portions 132 of the clamps 116 to hold the bottom portions 132 to the base member 14. The energy storage components 12 are then placed onto the bottom portions 132 of the clamps in an axial in-line arrangement in which the terminals 22 of the energy storage components 12 rest in the recesses 134 of the bottom portions 132 of the clamps 116. The top portions 130 of the clamps 116 are then placed over the terminals 22 of the energy storage components 12 and connectors (e.g., bolts) are used to connect the top portions 130, the bottom portions 132, and the base member 14 by engaging the pem nut (or other connector). The terminals 22 of the energy storage components 12 can be secured by tightening the bolts through the holes 136 of the clamps 116.

Module terminals may be installed by electrically connecting the module terminals to the terminals 22 of two or more of the energy storage components 12 (e.g., using the clamps 116 disposed at the end of a row of energy storage components 22), and rows of energy storage components 12 may be connected together, such as by a bus bar or other connectors as described below. In some implementations a thermal interface material may be placed over the top of the energy storage components 12 and clamps 116 to provide a thermal conduction path to transfer thermal energy away from the energy storage components 12 through the clamps. A housing may then be assembled to enclose the energy storage components 12, the clamps 116, and the base member 14. This top-down assembly of the module provides an easy and efficient assembly that can greatly reduce assembly time and expense as well as protect the individual energy storage cells from potentially harmful processes, such as welding.

The module 10 provides wireless connections of the energy storage components 12. The direct connection of the energy storage components 12 through the clamps 116 provides an in-line configuration of the energy storage components 12 without much, if any, air volume between the inline energy storage components 12, which allows for less volume of the overall module 10 (e.g., providing a higher energy density or capacity for the same volume of the module 10). The module 10 further provides a lower ESR than modules connected using bus bars or wired connections between the individual energy storage components. The module 10 also can be assembled with wide tolerance variations in the energy storage components (e.g., the individual clamps may be tightened as necessary to provide a secure connection) and is easier to assemble (or disassemble for repair) than modules in which individual energy storage components are welded or otherwise connected to bus bars, wires, or the like.

FIGS. 5 and 6 depict a front view and side view, respectively, of the clamp 116 shown in FIG. 4. In FIGS. 5 and 6, example dimensions of the clamp 116 are shown. In particular, the top portion 130 and the bottom portion 132 of the clamp 116 may have a length 140 of about 2.38 inches, a height 142 of about 1.18 inches, a recess diameter 144 of about 0.55 inches, and a width 146 of about 0.25 inches. The width 146 of the clamp 116, for example, may be wide enough to secure one or more of the energy storage components in an end-to-end configuration by contacting enough of each end to secure each energy storage component (e.g., about 0.125 inches in the example described above).

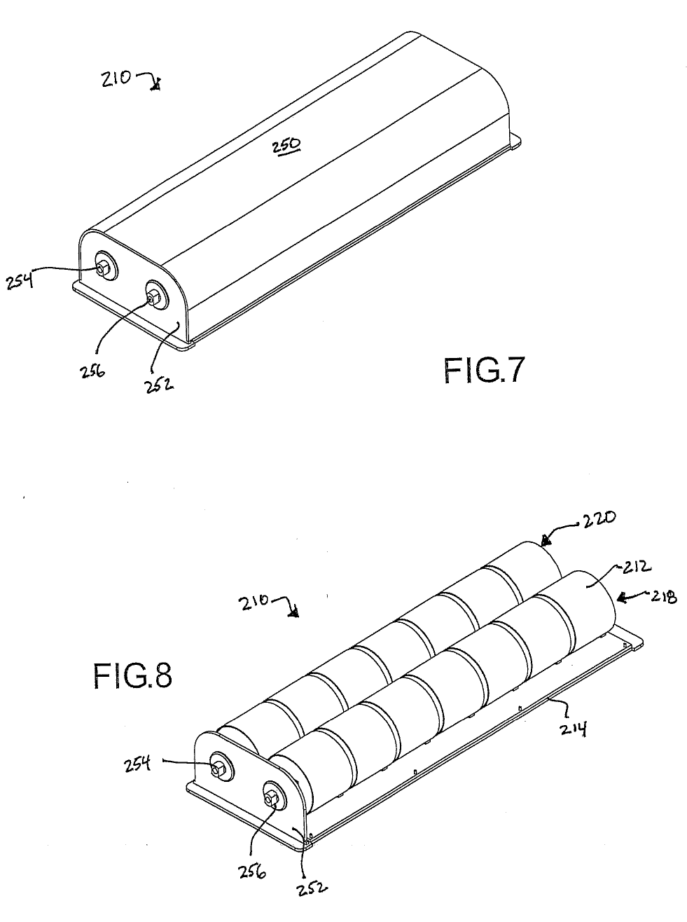

FIG. 7 depicts a perspective view of a second example of an electrical module 210 in which the electrical module 210 comprises a housing 250, an end plate 252 and a pair of module terminals 254 and 256. FIG. 8 shows the electrical module 210 without the housing 250. FIGS. 10-12 further depict a top view, a side view, and an end view of the electrical module as shown in FIG. 8 without the housing connected. As shown in FIG. 8, the electrical module 250 comprises two rows 218 and 220 of series connected in-line energy storage components 212 that are secured to a base member 214. Each of the two rows 218 and 220 of series connected energy storage components 212 are electrically connected to one of the terminals 254 and 256. As discussed above with respect to FIGS. 1-3, the two rows 218 and 220 of series connected energy storage components 212 may be independent (e.g., sub-modules) or may be connected to each other as part of a single electrical module with the same terminals. Where the rows 218 and 220 are independent, for example, additional module terminals may be provided on the opposite end of the electrical module 210 from the module terminals 254 and 256 shown in FIG. 8. Alternatively, the two rows 218 and 220 of series connected energy storage components may be connected in series with each other. In this configuration, the end energy storage components 212 of each row 218 and 220 located opposite the module terminals 254 and 256 may be electrically connected to each other to connect the two rows 218 and 220 in series. A double clamp (as described below), a bus bar, or another electrical connector may be used to connect the rows 218 and 220 in series within the electrical module 210.

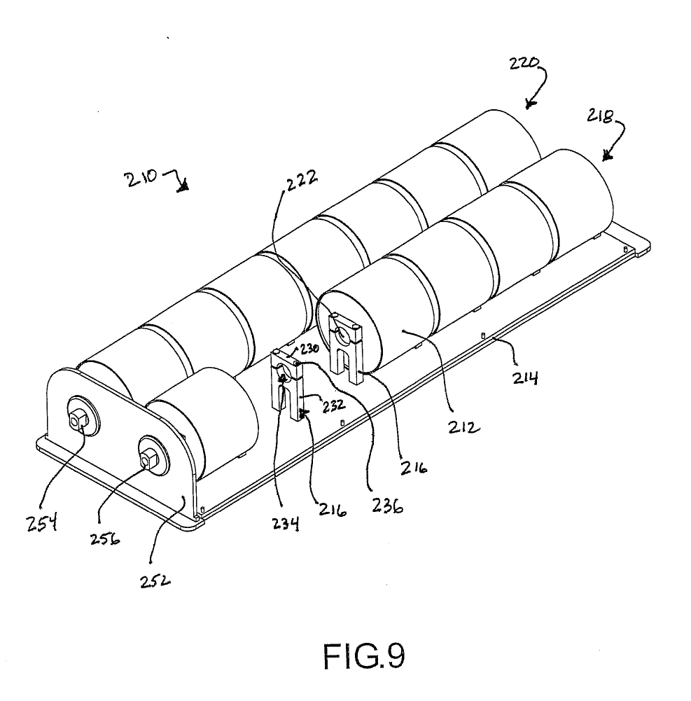

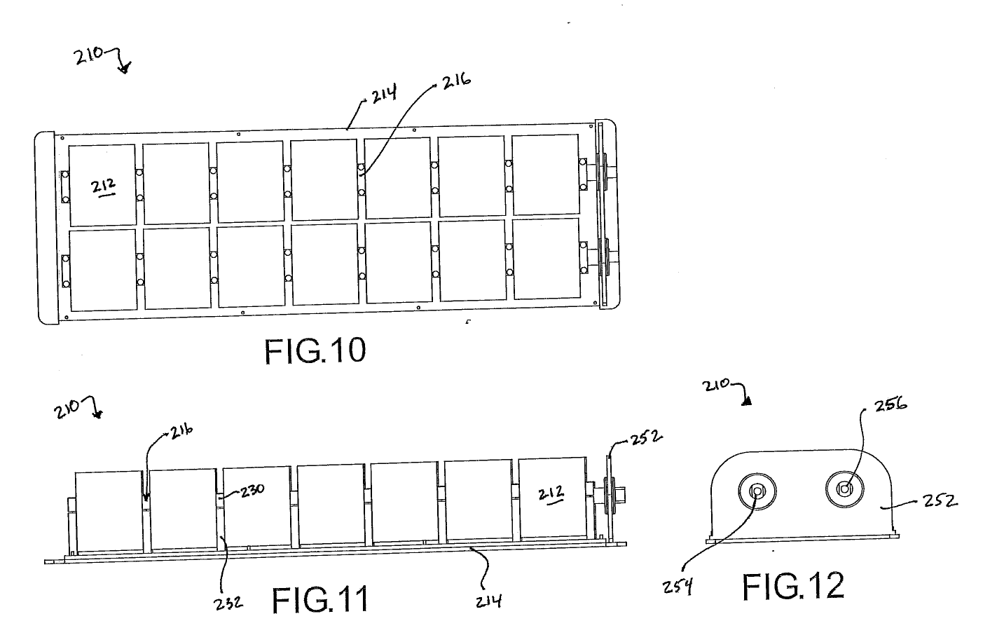

FIG. 9 depicts a perspective view of the electrical module 210 of FIGS. 7 and 8 with two energy storage components 212 of the electrical module 210 removed to illustrate a pair of clamps 216 of the electrical module 210. The clamps 216 illustrated in FIG. 9 each comprise a top portion 230 and a bottom portion 232 and a recess 234 in at least one of the portions for engaging a portion (e.g., a terminal or other portion) of the energy storage components 212. The clamps 216 further comprise at least one hole 236 through which a connector may be inserted to secure the top portion 230 to the bottom portion 232 of the clamp 216. In use, the connector may secure a portion (e.g., a terminal) of one or more energy storage components 212 within the recess 234 of the clamp 216. The connector 234 may also optionally secure the clamp 216 and the electrical component 212 to the base member 214.

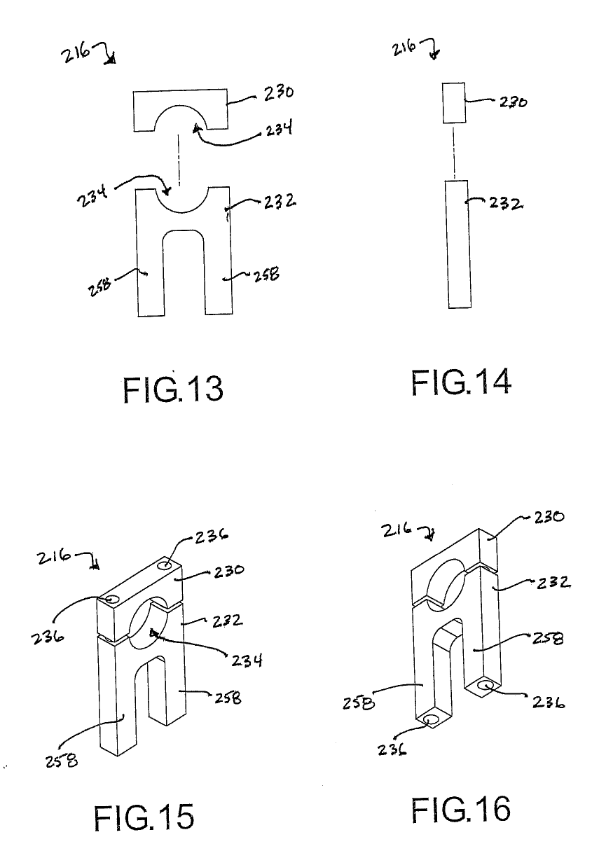

FIGS. 13-16 depict the second example of a clamp as shown in FIG. 9. As shown in FIGS. 13-16, the clamp 216 comprises the top portion 230 and bottom portion 232. The recess 234 extends into both the top portion 230 and the bottom portion 232 although only one portion may comprise a recess 234. Again, the recesses 234 are shown as generally semicircular recesses although other shaped recesses (e.g., angled recesses as shown in FIG. 17) may also be used. The lower portion 234 of the clamp 216 includes a pair of legs 258 that extend toward the base member 214. An open region 260 extends between the pair of legs 258. The open region provides less material and a lighter construction of a clamp. The opening may further provide an opening that allows for heat dissipation.

As described above, the holes 236 need not extend fully through the entire clamp, but may, for example, be threaded on one or both ends to receive and engage a threaded connector from the top or the bottom of the clamp. The holes 236 may also be counter-sunk at one or both ends so that the head of a male connector (e.g. a bolt) and/or a female connector (e.g., a nut) may be disposed within the counter-sunk hole 236 of the clamp 216.

FIG. 17 shows a third example clamp 316 that comprises a single piece clamp. The clamp 316 comprises an open side 362 and a closed side 364. On the open side 362, the clamp 316 comprises a slot 366 for receiving a portion (e.g., a terminal) of an energy storage component and a recess 334. In this implementation the recess 334 comprises angled walls (although other shapes and configurations are also possible) for engaging the portion of the energy storage component disposed within the recess 334 when a connector is inserted through a hole 336 to close the slot 366 and engage the portion of the energy storage component within the recess 334 of the clamp 316. In this manner, only a single hole 336 and connector are used to tighten the clamp 316 around a portion of the energy storage component and may simplify assembly of the module. As discussed above, the clamp 316 may also be connected to a substrate (e.g., a PC board) via the connector extending through the hole 336 and optionally other connections. Further, the hole 336 need not extend fully through the entire clamp 316, but may, for example, be threaded on one or both ends to receive and engage a threaded connector from the top or the bottom of the clamp. The hole 336 may also be counter-sunk at one or both ends so that the head of a connector (e.g. a bolt) and/or a nut may sit within the counter-sunk hole 336 of the clamp 316.

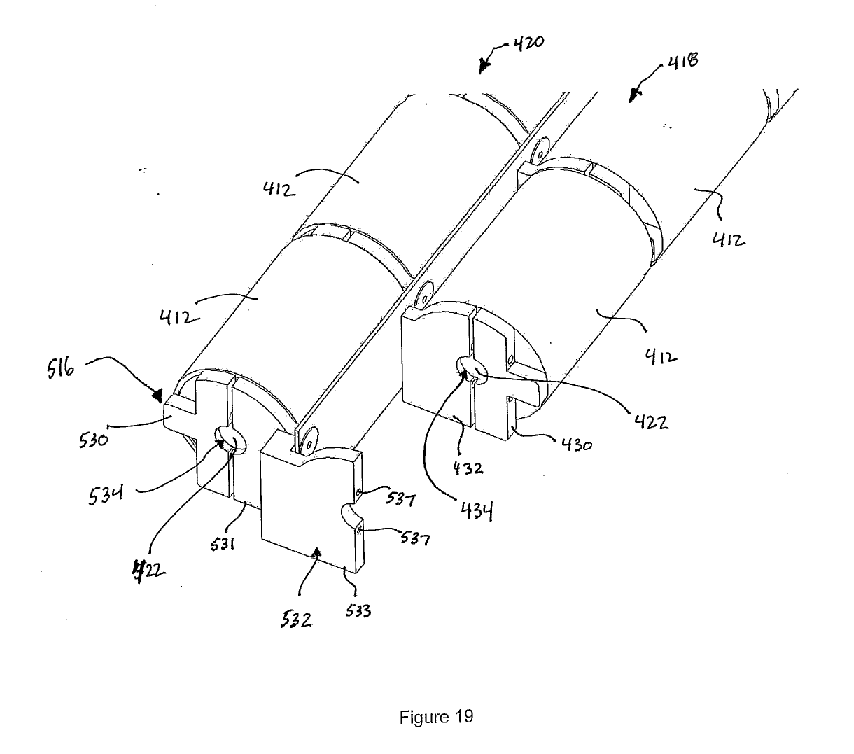

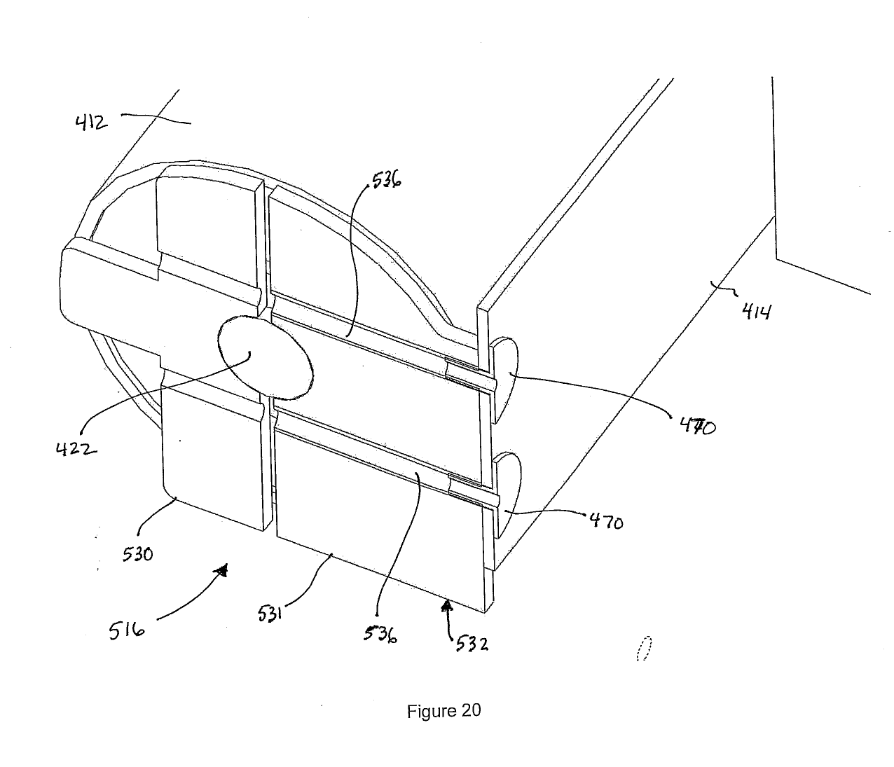

FIGS. 18 and 19 depict a third example of an electrical module 410 in which a plurality of energy storage components 412 are secured to a base member 414 of the module 410. As shown in FIGS. 18 and 19, the module 410 comprises two rows 418 and 420 of series connected in-line energy storage components 412. The individual energy storage components 412 are secured to the base member 414 via a third embodiment of a fourth example of a clamp 416. Again, the clamps 416 comprise a top portion 430 and a bottom portion 432, at least one of which comprises a recess 434 that engages a terminal 422 of the energy storage components 412 of the module 410 as described above with respect to other example clamps.

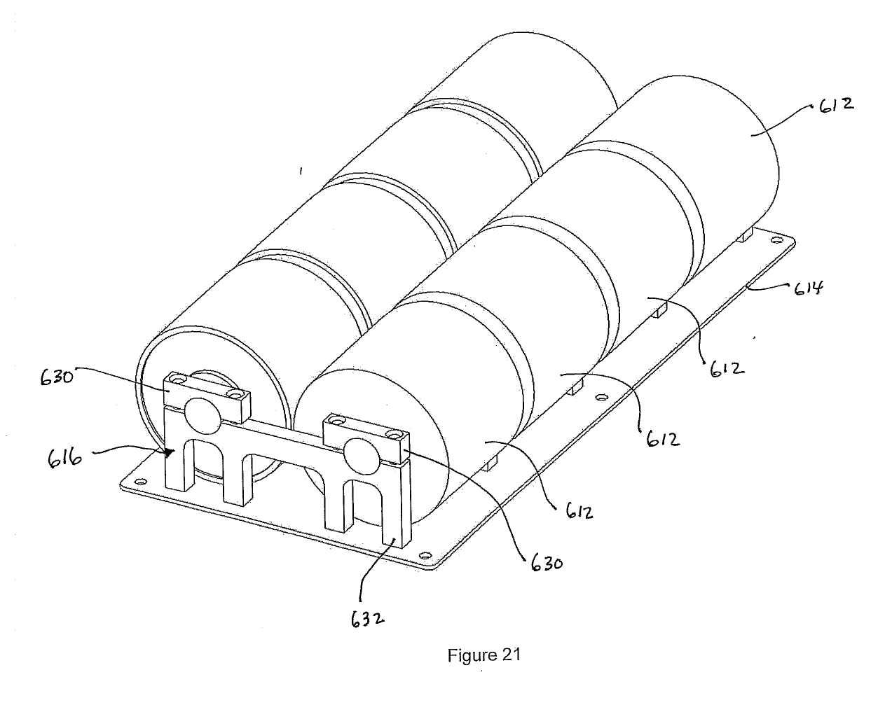

A fifth example of a clamp is also shown in FIGS. 18-20. An end-piece clamp 516 is shown in FIGS. 18 and 19, and FIG. 20 shows a cross-sectional view of the left side of the end-piece clamp 516. The end-piece clamp 516 allows for an electrical connection of two side-by-side end energy storage components 412. The particular implementation of the end-piece clamp 516, for example, comprises two end portions 530 and a common middle portion 532 that electrically connects the terminals 422 of the side-by-side energy storage components 412. The common middle portion 532 extends between offset terminals 422 of the energy storage components 412. The portion shown connected to the left energy storage component 412 in FIGS. 18-20, for example, comprises holes 536 extending entirely through left half 531 of the middle portion 532. A connector (e.g., a bolt) may be extended through the end portion 530 of the clamp 516 and the left half 531 of the middle portion 532 of the clamp 516 to secure the clamp to the base member 414 via a nut 470. The right half 533 of the middle portion 532 of the clamp 516 extends around a longitudinal end of the base member 414 to the terminal 422 of the adjacent energy storage component 412. The right half 533 of the middle portion 532 of the clamp 516 further comprises threaded (e.g., drilled and tapped) holes 537 that may be engaged by a connector extending through the top portion 530 on the right side of the clamp 516.

FIG. 21 depicts a sixth example of a clamp 616 for securing two side-by-side energy storage components 612 to each other and to a base member 614. The clamp 616 comprises a pair of top portions 630 and a single bottom portion 632. In the configuration shown in FIG. 21, the top portions 630 and the bottom portion 632 each comprise a recess 634 for engaging a portion of the energy storage components 612. The bottom portion comprises a solid connector that extends between the pair of energy storage components 612 to make an electrical connection between the two energy storage components. In other configurations, both the top and bottom portions may extend between the energy storage components or only the top portion may extend between the energy storage components.

Although several embodiments of this invention have been described above with a certain degree of particularity, those skilled in the art could make numerous alterations to the disclosed embodiments without departing from the spirit or scope of this invention. For example, electrical components are generally illustrated as cylindrical energy storage cells having terminals disposed on opposite ends, other configurations and form factors of electrical components may be used in any of the examples discussed above. Some energy storage cells or other electrical components comprise terminals or other portions extending from the same or adjoining sides of various shaped (e.g., cylindrical, parallelepiped, square, rectangular) instead of from opposite sides. For example, although electrical clamps are discussed herein that connect energy storage components having axial terminals, the clamps may also be configured to connect energy storage components having terminals in other configurations (e.g., offset terminals of electrical components). All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An electrical module comprising:
a first energy storage component comprising a first terminal and a second terminal;
a second energy storage component comprising a third terminal and a fourth terminal; and
a clamp comprising a recess that receives at least a portion of the first terminal of the first energy storage component and at least a portion of the third terminal of the second energy storage component, the clamp electrically connecting the first terminal of the first energy storage component to the third terminal of the second energy storage component, wherein the first energy storage component and the second energy storage component are arranged in a generally in-line configuration.

2. The electrical module of claim 1 wherein the second terminal of the first energy storage component is electrically connected to a first module terminal of the electrical module.

3. The electrical module of claim 2 wherein the fourth terminal of the energy storage component is electrically connected to a second module terminal of the electrical module.

4. The electrical module of claim 3 wherein the fourth terminal of the energy storage component is electrically connected to the second module terminal of the electrical module via at least one intervening energy storage component.

5. The electrical module of claim 1 wherein the clamp secures the first energy storage component and the second energy storage component to a base member.

6. The electrical module of claim 5 wherein the clamp electrically connects the first energy storage component and the second energy storage component to the base member.

7. The electrical module of claim 6 wherein the first energy storage component and the second energy storage component are electrically connected to at least one of a monitoring circuit and a charge balancing circuit via the base member.

8. The electrical module of claim 1 wherein the electrical module comprises a first row of energy storage component and a second row of energy storage components, the first energy storage component and the second energy storage component comprise at least a portion of the first row of energy storage components.

9. The electrical module of claim 8 wherein the first row of energy storage components and the second row of energy storage components are serially connected between a first module terminal and a second module terminal.

10. The electrical module of claim 8 wherein the first row of energy storage components and the second row of energy storage components are connected in parallel between a first module terminal and a second module terminal.

11. The electrical module of claim 8 wherein the first row of energy storage components and the second row of energy storage components comprise independent sub-modules of the electrical module.

12. The electrical module of claim 1 wherein the clamp comprises a connector extending through a hole to secure the first terminal of the first energy storage component and the third terminal of the second energy storage component.

13. The electrical module of claim 1 wherein the clamp comprises a connector extending through a hole to secure the clamp to a base member.

14. The electrical module of claim 1 wherein a housing at least partially surrounds the first energy storage component, the second energy storage component, and the clamp.

15. The electrical module of claim 14 wherein a thermal interface material is disposed between the clamp and the housing.

16. The electrical module of claim 1 wherein the clamp comprises an electrically conductive portion.

17. The electrical module of claim 1 wherein the clamp comprises a thermally conductive portion.

18. A method for assembling an electrical module, the method comprising:
providing a clamp;
providing a first energy storage component comprising a first terminal and a second terminal and a second energy storage component comprising a third terminal and a fourth terminal;
securing the first energy storage component to the second energy storage component in a generally in-line configuration via the clamp, wherein the clamp electrically connects the first terminal of the first energy storage component and the third terminal of the second energy storage component.

19. The method of claim 18 wherein the securing operation further secures the first energy storage component and the second energy storage component to a base member via the clamp.

20. The method of claim 19 wherein the securing operation further electrically connects the first terminal of the first energy storage component and the third terminal of the second energy storage component to the base member.

21. An electrical module comprising:
a first energy storage component comprising a first terminal and a second terminal;
a second energy storage component comprising a third terminal and a fourth terminal; and
a means for clamping at least a portion of the first terminal of the first energy storage component and at least a portion of the third terminal of the second energy storage component, the means for clamping electrically connecting the first terminal of the first energy storage component to the third terminal of the second energy storage component, wherein the first energy storage component and the second energy storage component are arranged in a generally in-line configuration.
